(19) United States
(12) Patent Application Publication
(10) Pub. No.: US 2026/0278713 A1
(43) Pub. Date: Sep. 17, 2026

(54) Dispute Resolution in Billing Information

(71) Applicant: Telefonaktiebolaget LM Ericsson (publ), Stockholm (SE)

(72) Inventors: Cristiane De Araujo Pereira Fabio, São Paulo (BR); Roberto Pires De Carvalho, São Paulo (BR); Juliana Coelho, São Paulo (BR); George Hamilton Fernandes Pirath, São Paulo (BR); Fabiano Sato, São Paulo (BR)

(21) Appl. No.: 19/167,687

(22) PCT Filed: Mar. 23, 2023
(86) PCT No.: PCT/SE2023/050264

§ 371 Date: Sep. 22, 2025

(51) Int. Cl. G06Q 50/18; G06Q 30/016; G06Q 30/04

(52) U.S. Cl. CPC G06Q 50/182; G06Q 30/016; G06Q 30/04

(57) ABSTRACT

Embodiments of the present disclose provide a method (400) for dispute resolution in billing information generated for communication services. The method (400) being performed by a computing device (104). The method (400) comprises receiving (402) a request message for a credit amount to be refunded to the customer account, said request message comprising the billing information related to a customer. The method (400) comprises determining (404) whether or not to refund the credit amount to the customer account based on an evaluation of the billing information. In response to the determination, the method (400) comprises initiating (406) credit refund to the customer account, altering the billing information or denying the request message. Corresponding computing device, billing dispute resolution system, and computer program products are also disclosed.

### TECHNICAL FIELD

The present disclosure relates generally to the field of billing systems. More particularly, it relates to method, computing device, billing dispute resolution system, and computer program products for dispute resolution in billing information generated for communication services

### BACKGROUND

Generally, Communication Service Providers, CSPs, all over the globe offer wide variety of services to a plurality of customers, by leveraging advantage of modern cellular systems, for example, 5G New Radio, NR, systems.

The plurality of customers may be post-paid customers. In such a scenario, besides providing the services to the plurality of customers, issuing billing information/invoices for accessing the services is a core step in a CSP business operation. With 5G and Internet of Things, IoT, services, complexity of post-paid billed customers can be increased due to a high number of billed devices and services and different billing use cases brought by 5G and IoT services.

The CSP may include a Quality Assurance, QA, team to identity issues/errors/inconsistencies in the billing information (i.e., to identify incorrect invoices) and to fix the issues prior to releasing the billing information to the customer. However, still the issues in the billing information can be inevitable and may not be solved before releasing the billing information to the customer.

FIG. 1 discloses an example existing approach of dispute resolution in billing information related to a customer. Typically, due to a substantial number of invoices/billing information with issues, a QA team composed of Subject Matter Experts, SMEs, performs a quality assurance before executing billing in production, sometimes in a different environment (pre-production/test). The QA team uses its own scripts and tools to manually find inconsistencies in a sample of preliminary billing information or automatically detect known inconsistency or inconsistency patterns in the billing information. The QA team shares results of findings with an operation team to provide fixes in a baseline or in an installed base depending on a root cause of the inconsistencies found in the billing information. However, some issues/inconsistences in the billing information cannot be detected and the customers can raise complaints about the issues present in their billing information.

For example, as depicted in FIG. 1, at step 1, an unhappy customer who finds issues/inconsistencies in the billing information contacts a call center and interacts with an Interactive voice response, IVR, system for raising a complaint about issues in the received billing information. At step 2, the IVR, system deployed by the call center collects the billing information for the customer and at step 3, the IVR system offers available options to the customer. At step 4, the customer selects an invoice dispute option. At step 5, the IVR system connects the customer with a level 1 support analyst. At step 6, the level 1 support analyst requests the customer for complaint information and at step 7, the customer provides the requested information (i.e., about the issues in the billing information). At step 8, the level 1 support analyst screens the complaint information received from the customer and at step 9, the level 1 support analyst opens a ticket and forwards the ticket to a level 2 system. Thus, forwarding the ticket into a billing dispute resolution process for detecting and resolving dispute in the billing information. At step 10, the level 1 support analyst obtains an acknowledgment from the level 2 system, once the ticket is registered by the level 2 system. Upon obtaining the acknowledgment, at step 11, the level 1 support analyst communicates the customer about opening of the ticket and about next steps involved in dispute resolution, within a pre-defined service level agreement, SLA, interval.

At step 12, the level 2 system assigns the ticket to a level 2 support analyst. At step 13, the level 2 support analyst screens the ticket and at step 14, triggers remedy actions for dispute resolution in the billing information. At step 15, the level 2 support analyst provides a response/answer indicating the triggered remedy actions to the level 2 system. At step 16, the level 2 system communicates the customer about the remedy actions triggered for dispute resolution in the billing information. In some examples, the remedy actions may include deciding credit refund to a customer account. However such a billing dispute resolution process can result in additional Operational Expenditure, OPEX, cost, since:
the QA team has to manually evaluate the tickets raised against the billing information;
the customer has to connect with the level 1 or level 2 support system for opening and analysing complaint cases; and
the overloaded QA team has to split their time for identifying the issues in the billing information before releasing the billing information and for the billing dispute resolution process.

Besides the increased OPEX cost, another consequence is the customer dissatisfaction with the incorrect billing information and delays in handling the credit refund against such billing information, which leads to increased churn rate.

### SUMMARY

It is essential to detect and resolve dispute in the billing information without involving manual effort/human intervention in order to decrease OPEX cost and utilization of a large amount of QA team resources and to improve customer satisfaction.

Consequently, there is a need for an improved method and arrangement for dispute resolution in the billing information that alleviates at least some of the above-cited problems.

It is therefore an object of the present disclosure to provide a method, a computing device, a billing dispute resolution system, and a computer program product for dispute resolution in the billing information generated for communication services, to mitigate, alleviate, or eliminate all or at least some of the above-discussed drawbacks of presently known solutions.

This and other objects are achieved by means of a method, a computing device, a billing dispute resolution system, and a computer program product as defined in the appended claims. The term exemplary is in the present context to be understood as serving as an instance, example or illustration.

According to a first aspect of the present disclosure, a method for dispute resolution in billing information generated for communication services is provided. The method is performed by a computing device. The method comprises receiving a request message for a credit amount to be refunded to a customer account, said request message comprising the billing information related to a customer. The method comprises determining whether or not to refund the credit amount to the customer account based on an evaluation of the billing information. In response to the determination, the method comprises initiating credit refund to the customer account, altering the billing information or denying the request message.

In some embodiments, the step of determining whether or not to refund the credit amount to the customer account based on the evaluation of the billing information comprises obtaining the billing information. The method comprises obtaining historical data of the customer comprising billing information of the customer for a pre-determined time interval. The method comprises comparing the billing information with the historical data of the customer to detect whether there exists any anomaly in the billing information. When the anomaly is detected in the billing information, the method comprises calculating a credit range of the billing information based on one or more statistical parameters derived from the historical data. When the anomaly is detected, the method comprises identifying whether a requested credit amount is within the credit range. When it has been identified that the requested credit amount is within the credit range, the method comprises determining to refund the credit amount to the customer account.

When it has been identified that the anomaly is not detected in the billing information or the requested credit amount is not within the credit range of the billing information, the method comprises determining to alter the billing information or to deny the request message.

In some embodiments, the step of evaluating the billing information by comparing with the historical data of the customer to detect whether there exits any anomaly in the billing information comprises obtaining the billing information. The method comprises obtaining the historical data of the customer for a pre-determined time interval and determining one or more statistical parameters from the historical data. The method comprises comparing the billing information with the one or more statistical parameters to detect whether there exists any anomaly in the billing information.

In some embodiments, the step of evaluating the billing information by comparing with the historical data of the customer to detect whether there exits any anomaly in the billing information comprises obtaining billing information details and identifying a billing cycle corresponding to the request. The method comprises obtaining historical billing information corresponding to one or more billing cycles preceding the identified billing cycle of the customer account. The method comprises comparing the billing information corresponding to the identified billing cycle with the historical billing information to detect whether there exists any anomaly in the billing information.

In some embodiments, the step of calculating the credit range based on analysis of the one or more statistical parameters derived from the historical billing information comprises obtaining a pre-defined tolerance for the billing information. The method comprises extracting one or more credit range rules pre-defined for determining the credit range. The method comprises evaluating the credit amount in the billing information, the one or more statistical parameters derived for the historical billing information, and the pre-defined tolerance in accordance with the one or more credit range rules. Based on the evaluation, the method comprises determining the credit range.

In some embodiments, the step of initiating the credit refund to the customer account comprises refunding the requested credit amount to the customer account, when it has been determined to refund the credit amount to the customer account.

In some embodiments, the step of initiating to alter the billing information or to deny the request message comprises performing one or more of: communicating the calculated credit range of the billing information to the customer, altering the billing information and redirecting the request message for manual resolution, when it has been determined that the requested credit amount is not within the credit range and the anomaly is detected in the billing information.

In some embodiments, the method comprises denying the request message and redirecting the request message for manual resolution, when it has been determined that the anomaly is not detected in the billing information.

According to a second aspect of the present disclosure, a computing device for performing dispute resolution in billing information generated for communication services is provided. The computing device is adapted for receiving a request message for a credit amount to be refunded to a customer account, said request message comprising the billing information related to a customer. The computing device is adapted for determining whether or not to refund the credit amount to the customer account based on an evaluation of the billing information. In response to the determination, the computing device is adapted for initiating credit refund to the customer account, altering the billing information or denying the request message.

According to a third aspect of the present disclosure, a billing dispute resolution system for dispute resolution in billing information generated for communication services is provided. The billing dispute resolution system comprises a computing device configured for receiving a request message for a credit amount to be refunded to a customer account, said request message comprising the billing information related to a customer. The computing device is configured for determining whether or not to refund the credit amount to the customer account based on an evaluation of the billing information. In response to the determination, the computing device is configured for initiating credit refund to the customer account, altering the billing information or denying the request message.

According to a fourth aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for effectively and efficiently resolving dispute in the billing information after releasing the billing information to the customer. The dispute in the billing information may be resolved based on detection of the anomaly in the billing information and comparison of the requested credit amount with the credit range of the billing information.

Some advantages of the embodiments are that:
the anomaly in the billing information may be detected with fewer cycles and without human intervention, which may lead to faster response time for triggering remedy actions to resolve dispute in the billing information;
the dispute in the billing information may be resolved by initiating remedy actions such as initiating the credit refund to the customer, altering the billing information, or the like. In some examples, the credit refund to the customer account may occur in different ways, for example, credit/payment refund if the credit amount in the billing information is already paid, altering the billing information if the credit amount in the billing information is not paid, future credit for next billing information, or the like. As a result, customer satisfaction may be improved.
resolution speed of dispute in the billing information may be increased, as the anomaly detection and the dispute resolution steps are performed without human intervention and performed in synchronous with reception of the request message/complaint from the customer.

Other advantages may be readily apparent to one having skill in the art. Certain embodiments may have none, some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses an example existing approach of dispute resolution in billing information related to a customer;

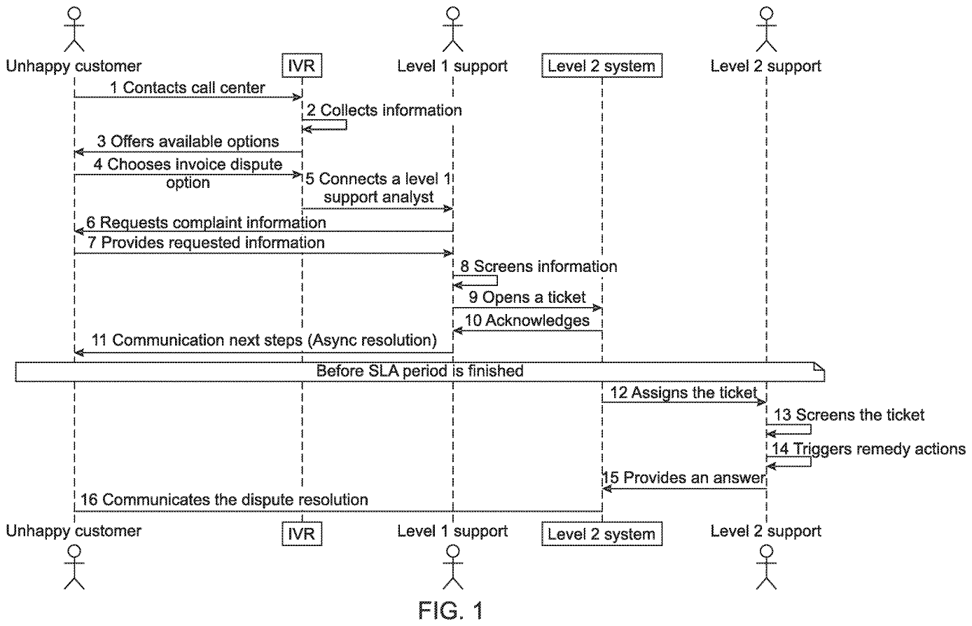

FIGS. 2A and 2B disclose a billing dispute resolution system according to some examples;

FIG. 3 discloses a computing device in a billing dispute resolution system adapted for dispute resolution in billing information according to some examples;

FIG. 4 is a flowchart illustrating method steps according to some examples;

FIG. 5 is a flowchart illustrating method steps according to some examples;

FIG. 6 discloses a sequence flow illustrating dispute resolution in billing information according to some examples;

FIG. 7 discloses a sequence diagram depicting steps for generating billing information and resolving dispute in the billing information according to some examples;

FIG. 8 discloses a flowchart illustrating remedy measures performed for resolving dispute in billing information according to some examples; and

FIG. 9 discloses a computing environment according to some examples.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the examples set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

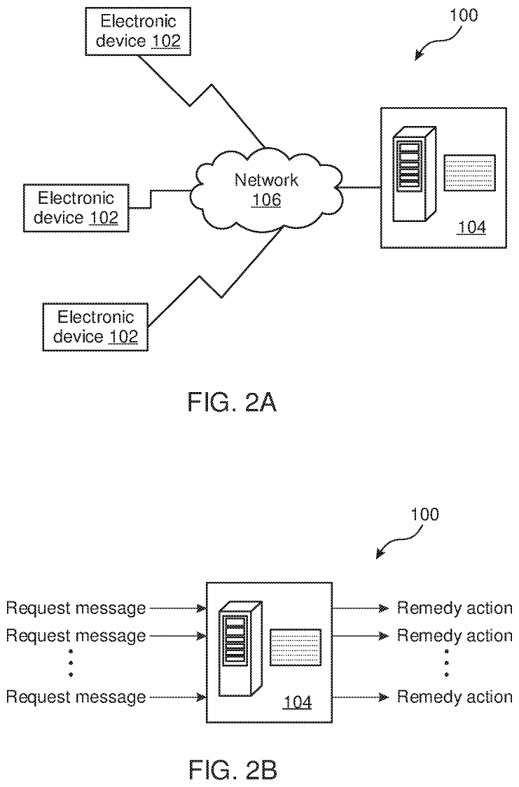

FIGS. 2A and 2B disclose a billing dispute resolution system 100. The billing dispute resolution system 100 referred herein is configured to resolve dispute in the billing information generated for communication services. In some examples, the communication services may include network delivered services. The network delivered service may be a subscription-based service comprising one or more of: a data service, a voice service, a multimedia broadcast multicast service, MBMS, and over-the-top, OTT service. In some examples, the communication services may also include fixed telephony services, cable television, TV, services, Internet services, and so on.

As depicted in FIGS. 2A and 2B, the billing dispute resolution system 100 comprises a computing device 104. As would be understood, the billing dispute resolution system 100 may comprise other components. Such components are not described for the sake of brevity.

The computing device 104 referred herein may include, but are not limited to, a server (for example, a standalone server, or a server residing in a cloud), a multi-processor system, a network computing device, a minicomputer, a mainframe computer, or a combination thereof. In some examples, the computing device 104 may also be a network node implemented in a communication network 106. In some examples, the communication network 106 may include, but are not limited to, a wired network, a cellular network, a wireless LAN, Wi-Fi, Bluetooth, Bluetooth low energy, Zigbee, Wi-Fi direct, WFD, Ultra-wideband, UWB, infrared data association, IrDA, near field communication, NFC, and so on. The computing device 104 may be implemented by a communication service provider, CSP, or an organization that provides communication services to the customer.

In some examples, the computing device 104 may generate billing information by charging/billing the communication services being accessed by a customer. The customer may be an end user accessing the communication services. The customer may also be an entity/organization accessing the communication services. The billing information (also be referred to as invoice) may identify one or more of: a number of communication services/items being accessed by the customer, charges/amount billed for the accessed communication services (i.e., credit amount), and billing cycle details (for example, month/year).

In some existing approaches, before releasing the billing information, a Quality Assurance, QA, team may be deployed for detecting issues (also be referred to as inconsistencies, errors, or the like) in the billing information generated for the communication services. The QA team may use its own scripts and tools to manually find the issues in a sample of preliminary billing information or automatically detect known issues or issue patterns in the billing information. Results of finding the issues in the billing information may be shared with an operational team to fix the issues. However, it may not be guaranteed all the times that the issues in the billing information have been found or fixed.

After releasing the billing information, if the customer finds any issues in the billing information, the customer raises complaints about the issues present in the billing information. The complaints raised by the customer may be forwarded to support analysts, who detect and solve disputes in the billing information. Thus, disputes in the billing information may be resolved with manual assistance, which may increase Operational Expenditure, OPEX, costs. Further, disputes in the billing information may not be resolved effectively with the manual assistance. In addition, the customer may be dissatisfied with delays that occur in solving disputes in the billing information, which may lead to increased churn rate.

Therefore, according to embodiments of the present disclosure, the computing device 104 implements a method for dispute resolution in billing information generated for the communication services.

The computing device 104 receives a request message for a credit amount to be refunded to a customer account. The customer account may be a billing account identifying one or more of: the communication services being accessed by the customer, and the billing information generated for the accessed communication services. The computing device 104 can be a server residing in a cloud environment for performing the billing dispute resolution.

In some examples, the computing device 104 may receive the request message from at least one electronic device 102 being used by the customer, as depicted in FIG. 2A.

In some examples, the electronic device 102 may be a device being used by the customer to access the communication services. Examples of the electronic device 102 may include, but are not limited to, a smart phone, a mobile phone, a cell phone, a voice over Internet Protocol, IP, VoIP, phone, a desktop computer, a personal digital assistant, PDA, a gaming console, a playback appliance, a wearable terminal device, a setup box, a tablet, a laptop, a wireless customer premise equipment, CPE, a vehicle mounted wireless terminal device, and so on.

The computing device 104 may receive the request message from the electronic device 102 through the communication network 106. In such a scenario, the communication network 106 may comprise the network node for generating service usage data related to the customer. The service usage data may identify one or more of: a number of communication services being accessed by the customer, charges to be applied on each communication service, or the like.

In some examples, the electronic device 102 may be a device being used by the customer to send the request message to the computing device 104. In such a scenario, the electronic device 102 may include a server, a fixed telephony, or the like.

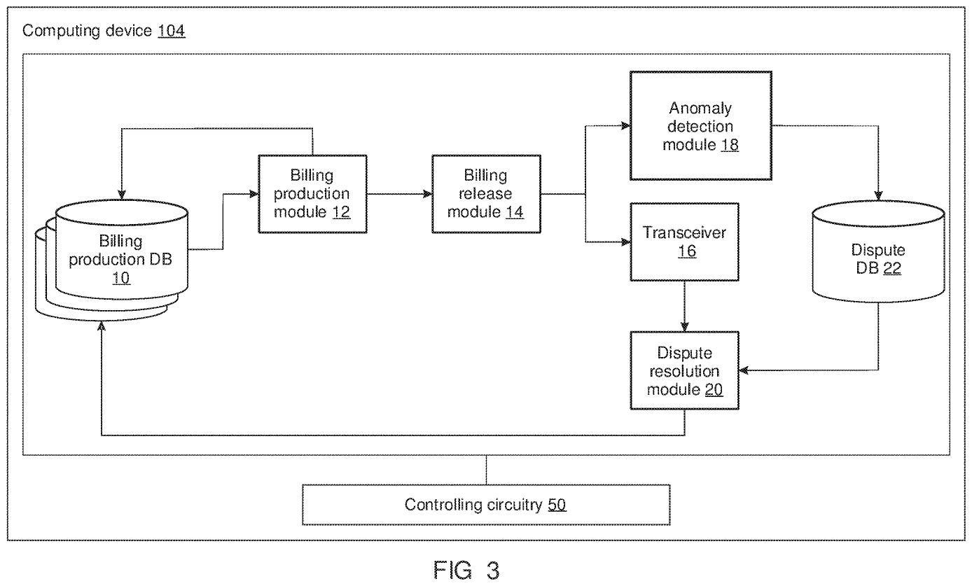

In some examples, the computing device 104 may implement an application from which the computing device 104 may receive the request message, as depicted in FIG. 2B. The application may also generate the service usage data related to the customer and the billing information based on the service usage data. The application may correspond to a billing production module as depicted in FIG. 3.

Upon receiving the request message, the computing device 104 determines whether or not to refund the credit amount to the customer account based on an evaluation of the billing information. In response to the determination, the computing device 104 initiates credit refund to the customer account, altering the billing information or denying the request message. Thus, dispute in the billing information may be resolved effectively without any delay.

Various embodiments for dispute resolution in the billing information are explained in conjunction with figures in the later parts of the description.

FIG. 3 discloses the computing device 104. The computing device 104 is capable of performing dispute resolution in the billing information.

According to an example, the computing device 104 in FIG. 3 comprises one or more modules. These modules may e.g., be a controlling circuitry 50, a billing production database, DB, 10, a billing production module 12, a billing release module 14, a transceiver 16, an anomaly detection module 18, a dispute resolution module 20, and a dispute DB 22. The controlling circuitry 50 may be adapted to control the above-mentioned modules 10-22.

The billing production DB 10, the billing production module 12, the billing release module 14, the transceiver 16, the anomaly detection module 18, the dispute resolution module 20, and the dispute DB 22, as well as the controlling circuitry 50, may be operatively connected to each other.

The billing production DB 10 may store one or more of: billing relevant data, historical data of the customer, and the billing information generated for the customer. In some examples, the billing relevant data may indicate at least one of, but is not limited to, a number of communication services/items being accessed by the electronic device (being used by the customer), billing amount/charges to be applicable on the accessed communication services, and so on.

The billing production module 12 may be configured to generate the billing information for the communication services being accessed by the customer. The billing production module 12 may retrieve the billing relevant data from the billing production DB 10 and generate the billing information based on the retrieved billing relevant data. The billing production module 12 may store the generated billing information in the billing production DB 10. Optionally, upon generating the billing information, the QA team may accept or reject the billing information.

The billing release module 14 may be configured to identify the billing information accepted by the QA team and forward the identified billing information to transceiver 16. The transceiver 16 may be configured to release the billing information to the respective customer. In some examples, the billing information may be transmitted to the electronic device being used by the customer, for example, via notification short messaging service, SMS. In some examples, the customer may be an end user accessing the communication services. In some examples, the customer may be an entity/organization.

The anomaly detection module 18 may be configured to detect whether there exists any anomaly in the billing information. The anomaly detection module 18 may also be configured to compute a credit range of the billing information, on detecting any anomaly in the billing information. The credit range may indicate maximum credit amount that can be refunded to the customer account. The anomaly detection module 18 may detect the anomaly in the billing information and calculate the credit range before receiving the request message/complaint from the customer and without any human intervention. As a result, the anomaly in the billing information may be detected with fewer cycles.

For detecting the anomaly in the billing information, the anomaly detection module 18 may obtain, from the billing production DB 10, the billing information related to the customer. The anomaly detection module 18 may also obtain, from the billing production DB 10, historical data of the customer. The historical data of the customer may comprise billing information of the customer for a pre-determined time interval (for example, the billing information of the customer for the latest 12 months). The anomaly detection module 18 may derive one or more statistical parameters from the historical data. Examples of the statistical parameters may include, but are not limited to, mean, median, quartiles, or the like. The anomaly detection module 18 may compare the billing information with the one or more statistical parameters to detect whether there exits any anomaly in the billing information.

Optionally, for detecting whether there exists any anomaly in the billing information, the anomaly detection module 18 may obtain the billing information and identify a billing cycle corresponding to the request. The anomaly detection module 18 may also obtain historical billing information corresponding to one or more billing cycles preceding the identified billing cycle of the customer account. The anomaly detection module 18 may compare the billing information corresponding to the identified billing cycle with the historical billing information to detect whether there exists any anomaly in the billing information.

When the anomaly is detected in the billing information, the anomaly detection module 18 may calculate the credit range of the billing information.

For calculating the credit range, the anomaly detection module 18 may obtain a pre-defined tolerance for the billing information. The pre-defined tolerance may be a refund limit defined for initiating the credit refund to the customer account. The anomaly detection module 18 may also extract one or more credit range rules pre-defined for determining the credit range. An example credit range rule pre-defined for determining the credit range is depicted in below table:

TABLE 1
(Example credit range rule)

| Credit Range Rule (per priority order) | Credit Range |
|---|---|
| Actual invoice amount > Maximum | Actual invoice amount -3rd quartile |
| historical Invoice amount * (1+ tolerance) | historical of invoice amount |
| Actual invoice amount > 3rd quartile | Actual invoice amount - median historical |
| historical invoice amount * (1+ tolerance) | quartile of invoice amount |
| Actual invoice amount > median historical | actual invoice amount - historical 1st |
| Invoice amount * (1+ tolerance) | quartile of invoice amount |
| Actual average amount per item > historical | (Actual average amount per item - |
| average amount per item | minimum historical average amount per |
| | item) * actual number of items |

Upon obtaining the pre-defined tolerance and extracting the credit range rules, the anomaly detection module 18 may evaluate the credit amount in the billing information, the one or more statistical parameters derived for the historical billing information, and the pre-defined tolerance in accordance with the one or more credit range rules. Based on the evaluation, the anomaly detection module 18 may calculate the credit range of the billing information.

The anomaly detection module 18 may store information about the anomaly detected in the billing information and the credit range calculated for the billing information in the dispute DB 22. In some examples, the anomaly detection module 18 may store information about the anomaly detected in the billing information and the credit range calculated for the billing information in the dispute DB 22 in the following structure:
Historical data of the customer:
   i) Number of items, quartiles of amount
Actual billing information of the customer:
   ii) Number of items, amount
Calculated/proposed credit range
   iii) Maximum credit range

Thus, the anomaly may be detected in the billing information in parallel with the release of the billing information to the customer.

The transceiver 16 may also be configured to receive a request message for a credit amount to be refunded to the customer account. The request message comprises the billing information related to the customer. The billing information may identify a number of communication services being accessed by the customer, and a billing amount charged/billed for the accessed communication services. In some examples, the transceiver 16 may receive the request message from the electronic device being used by the customer. In some examples, the transceiver 16 may receive the request message from an application being implemented by the computing device 104.

Upon receiving the request message, the dispute resolution module 20 may be configured for dispute resolution in the billing information. The dispute resolution module 20 determines whether or not to refund the requested credit amount to the customer based on evaluation of the billing information received in the request message.

For determining whether or not to refund the requested credit amount to the customer, the dispute resolution module 20 may obtain, from the dispute DB 22, the stored information about the anomaly detected in the billing information. Based on the obtained information, the dispute resolution module 20 may detect whether the anomaly is detected in the billing information received in the request message. If the anomaly is detected in the billing information, the dispute resolution module 20 may obtain, from the dispute DB 22, the credit range calculated for the billing information.

Upon obtaining the credit range of the billing information, the dispute resolution module 20 may identify whether the requested credit amount is within the credit range of the billing information. When it has been identified that the requested credit amount is within the credit range of the billing information, the dispute resolution module 20 may determine to refund the requested credit amount to the customer account.

When it has been identified that the requested credit amount is not within the credit range of the billing information or the anomaly is not detected in the billing information, the dispute resolution module 20 may determine not to refund the requested credit amount to the customer account.

In response to the determination, the dispute resolution module 20 initiates remedy actions/measures for dispute resolution in the billing information. The remedy actions comprise initiating credit refund to the customer account, initiating altering of the billing information, and denying the request message.

When it has been determined to refund the requested credit amount to the customer account, the dispute resolution module 20 initiates the credit refund to refund the requested credit amount to the customer account.

When it has been determined not to refund the requested credit amount to the customer account, the dispute resolution module 20 may identify whether the requested credit amount is within the calculated credit range or if the anomaly is detected in the billing information. When it has been determined that the requested credit amount is not within the credit range and the anomaly is detected in the billing information, the dispute resolution module 20 may perform one or more of: communicating the calculated credit range of the billing information to the customer, altering the billing information and redirecting the request message for manual resolution. When it has been determined that the anomaly is not detected in the billing information, the dispute resolution module 20 may deny the request message for the credit refund and redirect the request message for manual resolution.

The dispute resolution module 20 may also store information about the remedy actions performed for dispute resolution in the billing production DB 10.

Thus, with the proposed method, disputes in the billing information may be resolved in fewer cycles and without involving a large number of resources of the organization, which further may lead to faster response time.

Consider an example scenario, wherein a customer A has billing information/invoice (December 2022) of $263.57 and 16 items (i.e., a number of communication services/types of a communication service being accessed by the customer) and the customer decides to open a complaint against the billing information, requesting $10.00 of credit.

Prior to the customer complaint, the anomaly detection module 18 detects whether there exists any anomaly in the billing information. If the anomaly is detected in the billing information, the anomaly detection module 18 calculates the credit range for the billing information.

The anomaly detection module 18 may detect the anomaly in the billing information by comparing the billing information related to the customer with the historical data of the customer. For example, consider that the historical data may comprise the billing information of the customer for the latest 12 months, which is depicted in the below table:

TABLE 2
(Historical data of the customer)

| Billing information | | No of |
|---|---|---|
| (year-month) | Billing amount | Items |
| 2022 November | 250.42 | 15 |
| 2022 October | 251.23 | 14 |
| 2022 September | 252.17 | 16 |
| 2022 August | 253.15 | 15 |
| 2022 July | 255.1 | 17 |
| 2022 June | 251 | 13 |
| 2022 May | 248 | 12 |
| 2022 April | 249.89 | 14 |
| 2022 March | 253.13 | 15 |
| 2022 February | 200 | 11 |
| 2022 January | 251.15 | 13 |
| 2021 December | 254.1 | 16 |

The anomaly detection module 18 may calculate the credit range based on the one or more statistical parameters derived from the historical customer data, as depicted in the below table:

TABLE 3
(Credit range calculated with respect
to one or more statistical parameters)

| | |
|---|---|
| Hist Minimum | 200 |
| Hist 1st quartile | 250.2875 |
| Hist 2nd quartile | 251.19 |
| Hist 3rd quartile | 253.135 |
| Hist Maximum | 255.1 |
| Hist Avgperitem | 17.3649123 |
| Hist Items | 14.25 |
| Actual Amount | 263.57 |
| Actual Items | 16 |
| Actual AvgperItem | 16.473125 |
| Max Credit Amount | 10.435 |
| Tolerance | 2% |

The anomaly detection module 18 stores information about the detection of anomaly in the billing information and the credit range for the billing information in the dispute DB 22.

Upon receiving the complaint, the dispute resolution module 20 determines that the anomaly is detected in the billing information, from the stored information in the dispute DB 22. Upon determining the anomaly in the billing information, the dispute resolution module 20 obtains, from the dispute DB 22, the credit range of the billing information. The dispute resolution module 20 compares the requested credit amount with the credit range of the billing information and identifies that the requested credit amount is within the credit range of the billing information. Since the requested credit amount is within the credit range of the billing information, the dispute resolution module 20 initiates the credit refund to refund the requested amount to the customer account.

Thus, in embodiments herein, as the anomaly in the billing information is already detected before receiving the request message/complaint from the customer, dispute in the billing information may be resolved without any delay.

Consider an example scenario, wherein a customer B has billing information/invoice (December 2022) of $298.70 and 20 items (i.e., a number of communication services/types of a communication service being accessed by the customer) and the customer decides to open a complaint against the billing information, requesting $50.00 of credit.

Prior to the customer complaint, the anomaly detection module 18 detects whether there exists any anomaly in the billing information. Upon detecting the anomaly in the billing information, the anomaly detection module 18 calculates the credit range for the billing information. The anomaly detection module 18 may detect the anomaly in the billing information by comparing the billing information related to the customer with the historical data of the customer. For example, the historical data may comprise the billing information of the customer for the latest 12 months, which is depicted in the below table:

TABLE 4
(Historical data of the customer)

| Billing information | | |
|---|---|---|
| (year-month) | Billing amount | No of Items |
| 2022 November | 250.42 | 15 |
| 2022 October | 251.23 | 14 |
| 2022 September | 252.17 | 16 |
| 2022 August | 253.15 | 15 |
| 2022 July | 255.1 | 17 |
| 2022 June | 251 | 13 |
| 2022 May | 248 | 12 |
| 2022 April | 249.89 | 14 |
| 2022 March | 253.13 | 15 |
| 2022 February | 200 | 11 |
| 2022 January | 251.15 | 13 |
| 2021 December | 254.1 | 16 |

The anomaly detection module 18 may calculate the credit range based on the one or more statistical parameters derived from the historical customer data, as depicted in the below table:

TABLE 5
(Credit range calculated with respect
to one or more statistical parameters)

| | |
|---|---|
| Hist Minimum | 200 |
| Hist 1st quartile | 250.2875 |
| Hist 2nd quartile | 251.19 |
| Hist 3rd quartile | 253.135 |
| Hist Maximum | 255.1 |
| Hist Avg per item | 17.3649123 |
| Hist Items | 14.25 |
| Actual Amount | 298.7 |
| Actual Items | 20 |
| Actual Avg per item | 14.935 |
| Max Credit Amount | 45.565 |
| Tolerance | 2% |

The anomaly detection module 18 stores information about the detection of anomaly in the billing information and the credit range for the billing information in the dispute DB 22.

Upon receiving the complaint, the dispute resolution module 20 determines that the anomaly is detected in the billing information from the stored information in the dispute DB 22. Upon determining the anomaly in the billing information, the dispute resolution module 20 obtains, from the dispute DB 22, the credit range of the billing information. The dispute resolution module 20 compares the requested credit amount with the credit range of the billing information and identifies that the requested credit amount is not within the credit range of the billing information. Since the requested credit amount is not within the credit range of the billing information, the dispute resolution module 20 performs one or more of: altering the billing information, communicating the credit range of the billing information to the customer, and redirecting the request message to the manual resolution.

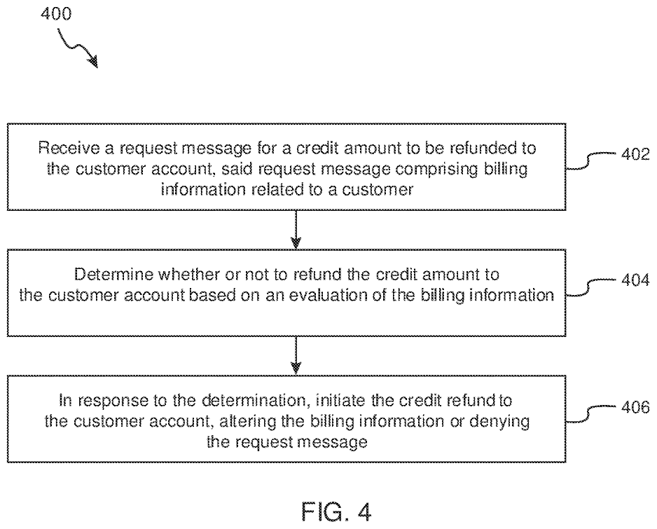

FIG. 4 is a flowchart illustrating example method steps of a method 400 performed for dispute resolution in the billing information. The method 400 is performed by the computing device. At step 402, the method 400 comprises receiving a request message for a credit amount to be refunded to the customer account. The request message comprises billing information related to the customer. In some examples, the billing information may identify one or more of: the communication services accessed by the customer, and a billing amount.

At step 404, the method 400 comprises determining whether or not to refund the credit amount to the customer account based on evaluation of the billing information.

In some embodiments, the step 404 may comprise detecting whether there exists any anomaly in the billing information. When the anomaly is detected in the billing information, the method may comprise calculating the credit range for the billing information. The credit range may indicate maximum credit amount that can be refunded to the customer account.

The method may comprise identifying whether the requested credit amount is within the credit range calculated for the billing information. Based upon identification, the method may comprise determining whether or not to refund the credit amount to the customer account.

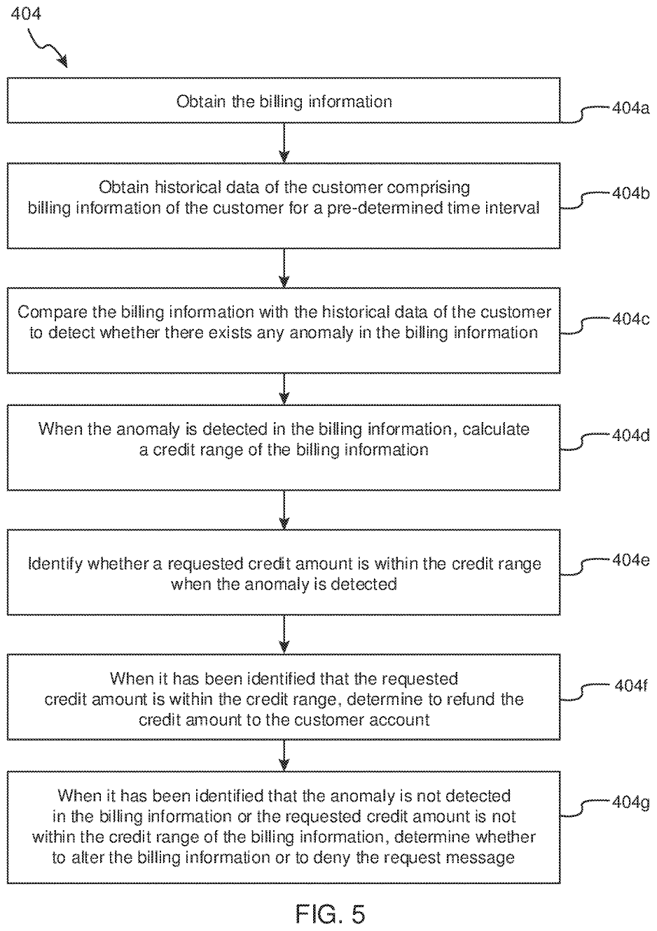

Step 404 of determining whether or not to refund the credit amount to the customer account based on evaluation of the billing information is described in detail in conjunction with FIG. 5.

In response to the determination, at step 406, the method 400 comprises initiating the credit refund to the customer account, altering the billing information or denying the request message.

In some embodiments, the step 406 of initiating the credit refund to the customer account may comprise refunding the requested credit amount to the customer account when it has been determined to refund the requested credit amount to the customer account.

In some embodiments, the step 406 of initiating to alter the billing information or to deny the request message may comprise determining whether the requested credit amount is not within the calculated credit range or if the anomaly is detected in the billing information, when it has been determined not to refund the credit amount to the customer account. When it has been determined that the requested credit amount is not within the credit range and the anomaly is detected in the billing information, the method may comprise performing one or more of: communicating the calculated credit range of the billing information to the customer, altering the billing information and redirecting the request message for manual resolution. When it has been determined that the anomaly is not detected in the billing information, the method may comprise denying the request message and redirecting the request message for manual resolution.

Thus, disputes in the billing information may be effectively and efficiently resolved by detecting the issue in the billing information without requiring any manual assistance. As a result, the request message/complaints received from the customer may be resolved in fewer cycles without any delay, which may improve customer satisfaction.

FIG. 5 is a flowchart illustrating example sub steps of method step 404 performed by the computing device for determining whether or not to refund the credit amount to the customer account based on the evaluation of the billing information.

At step 404a, the method comprises obtaining the billing information related to the customer. In some examples, the billing information may identify one or more of: the communication services accessed by the customer, and a billing amount.

At step 404b, the method comprises obtaining historical data of the customer comprising billing information of the customer for a pre-determined time interval. For example, the billing information of the customer for the latest 12 months may be obtained.

At step 404c, the method comprises comparing the billing information with the historical data of the customer to detect whether there exits any anomaly in the billing information.

In some embodiments, the step 404c may comprise determining one or more statistical parameters from the historical data. In some examples, the statistical parameters may include mean, median, quartile, or the like. The method may comprise comparing the billing information with the one or more statistical parameters to detect whether there exists any anomaly in the billing information.

Optionally, the step 404c may comprise obtaining billing information and identifying the billing cycle. The method may comprise obtaining historical billing information corresponding to one or more billing cycles preceding the identified billing cycle of the customer account. The method may comprise comparing the billing information corresponding to the current billing cycle and the historical billing information to detect whether there exists any anomaly in the billing information.

When the anomaly is detected in the billing information, at step 404d, the method comprises calculating a credit range of the billing information based on one or more statistical parameters derived from the historical data. The credit range may be the maximum amount that can be refunded to the customer.

In some embodiments, the step 404d may comprise obtaining a pre-defined tolerance for the billing information. The method may comprise extracting one or more credit range rules pre-defined for determining the credit range. The method may comprise evaluating the credit amount in the billing information, the one or more statistical parameters derived for the historical billing information, and the pre-defined tolerance in accordance with the one or more credit range rules. Based on the evaluation, the method may comprise determining the credit range. An exemplary credit range rule is described in conjunction with FIG. 3.

Upon calculating the credit range, at step 404e, the method comprises identifying whether a requested credit amount is within the credit range when the anomaly is detected. When it has been identified that the requested credit amount is within the credit range, at step 404f, the method comprises determining to refund the credit amount to the customer account. When it has been identified that the anomaly is not detected in the billing information or the requested credit amount is not within the credit range of the billing information, at step 404g, the method comprises determining whether to alter the billing information or to deny the request message.

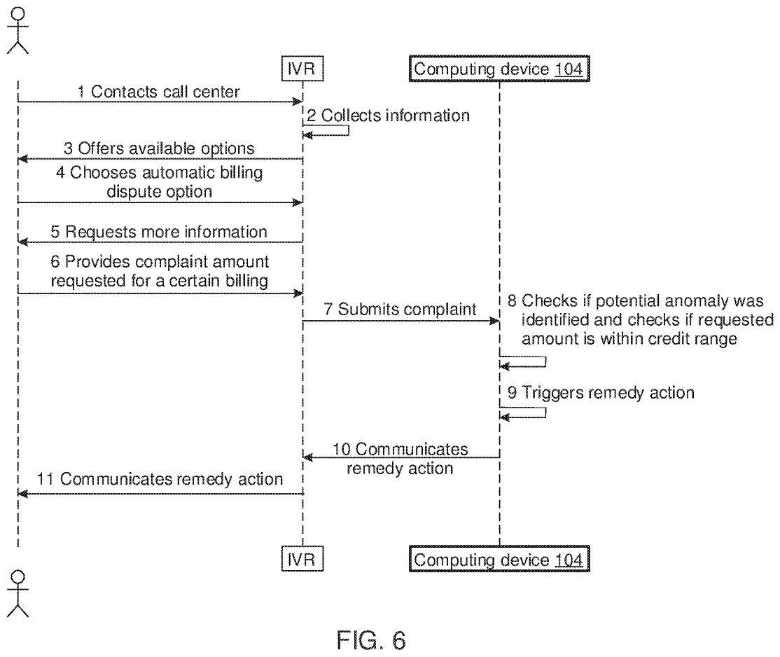

FIG. 6 discloses an example sequence flow illustrating dispute resolution in the billing information. In an example herein, consider that the customer has received the billing information generated for the communication services and detected issues in the billing information. Thereby, the customer is dissatisfied/unhappy about the billing information. In such a scenario, the customer using the electronic device contacts (1) a call center and interacts with a computer-operated telephone system like an Interactive voice response, IVR, system. The IVR system collects (2) information related to the customer such as, the communication services accessed by the customer, the billing information, or the like. Based on the collected information, the IVR system offers (3) available options to the customer. In an example herein, the customer (4) chooses an automatic invoice (billing information) dispute resolution option. The IVR system further requests (5) the customer for more information such as, information related to anomaly detected in the billing information, the credit amount to be refunded to the customer account, and so on. Accordingly, the customer sends (6) a request message for the credit amount/complaint amount to be refunded to the customer account against the billing information. The IVR system submits (7) request message of the customer/complaint raised by the customer to the computing device 104. The request message comprises the billing information related to the customer and the credit amount requested to be refunded to the customer account.

Upon receiving the request message from the customer, the computing device 104 determines (8) whether or not to refund the credit amount to the customer account by detecting whether there exits any anomaly in the billing information and identifying whether the requested credit amount is within the credit range calculated for the billing information on detection of the anomaly in the billing information.

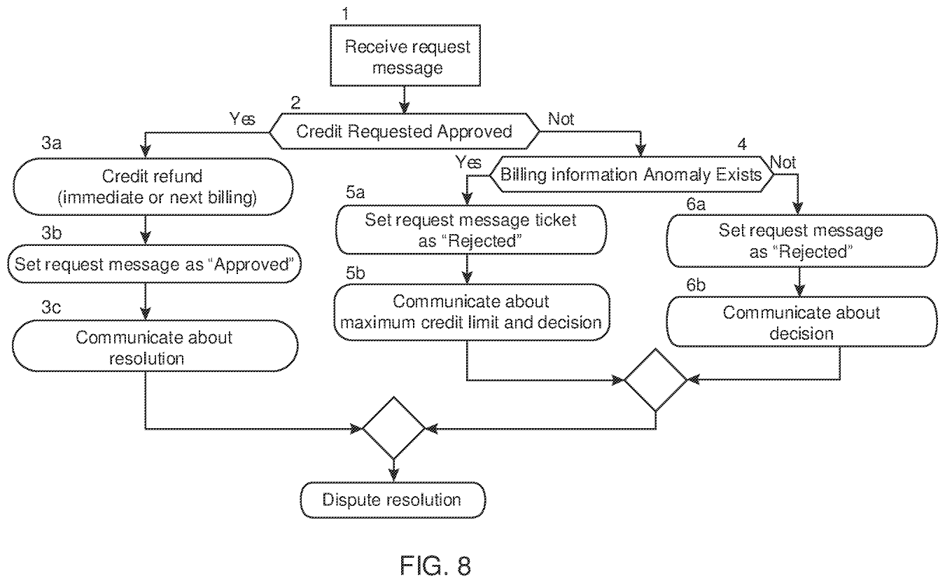

The computing device 104 triggers (9) remedy actions based on the determination at step 8. The remedy actions include initiating refunding of the requested credit amount to the customer or altering the billing information or denying the request message. The remedy actions are described in detail in conjunction with FIG. 8.

The computing device 104 communicates (10) the triggered remedy actions to the IVR system, which further communicates (11) the remedy actions to the customer. Thus, the customer-raised complaints against the billing information may be immediately checked and decision may be automatically derived without any human intervention.

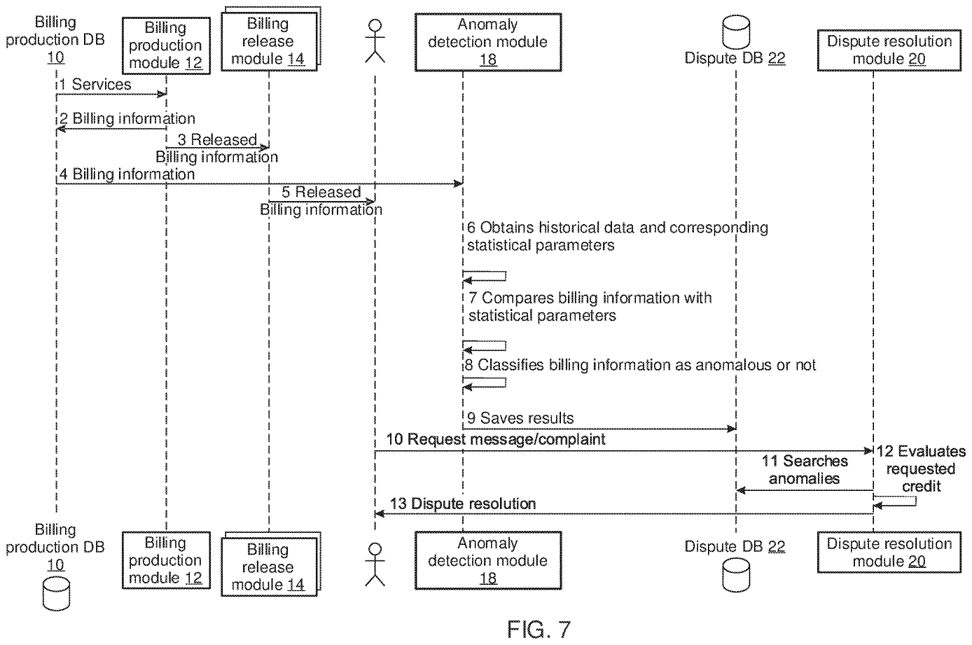

FIG. 7 discloses an example sequence diagram depicting steps performed for generating billing information for the communication services and resolving dispute in the billing information. Steps may be performed by different modules of the computing device, as described below.

The billing production module 12 retrieves (1), from the billing production DB 10, billing relevant data identifying the communication services accessed by the customer and charging of the accessed communication services. The billing production module 12 generates the billing information/invoice against the customer based on the retrieved billing relevant data and stores (2) the billing information/invoice in the billing production DB 10. The billing release module 14 releases (3) the generated billing information for further analysis. The QA team analyses the billing information and accepts/rejects the billing information. The accepted billing information is released (5) to the respective customer. The billing release module 14 also communicates (4) the generated and stored billing information in the billing production DB 10 to the anomaly detection module 18.

The anomaly detection module 18 detects whether there exists any anomaly in the billing information. For detecting the anomaly in the billing information, the anomaly detection module 18 obtains (6) the historical data of the customer comprising billing information of the customer for latest 12 months and derives the one or more statistical parameters from the historical data. The anomaly detection module 18 compares (7) the billing information with the one or more statistical parameters. Based on the comparison, the anomaly detection module 18 classifies (8) the billing information as anomalous or not. The anomaly detection module 18 also calculates the credit range of the billing information, if the billing information is classified as anomalous. The anomaly detection module 18 stores (9) classification of the billing information and the credit range if calculated for the billing information in the dispute DB 22.

Meanwhile, the customer sends (10) a request message/complaint to the dispute resolution module 20 for the credit amount to be refunded to the customer account. The request message comprises the billing information related to the customer. Upon receiving the request message, the dispute resolution module 20 detects (11) if the billing information received in the request message is classified as anomalous or not from the stored information in the dispute DB 22. When it is detected that the billing information is classified as anomalous, the dispute resolution module 20 evaluates (12) if the requested credit amount is within the credit range of the billing information. Based on the evaluation, the dispute resolution module 20 resolves (13) dispute in the billing information. The dispute resolution module 20 resolves disputes in the billing information by performing one or more of: initiating the refund to the customer account, altering the billing information, or the like. When it is detected that the billing information is not classified as anomalous, the dispute resolution module 20 denies the request message.

FIG. 8 discloses an example flowchart describing remedy actions/measures performed for resolving disputes in the billing information. The computing device may comprise the dispute resolution module for dispute resolution in the billing information. At step 1, the dispute resolution module 20 receives a request message from the customer for the credit amount to be refunded to the customer account. The request message comprises the billing information related to the customer. The billing information may be generated for the communication services accessed by the customer.

For resolving dispute in the billing information, at step 2, the dispute resolution module 20 checks whether the request message (i.e., credit request) has been approved to refund the requested credit amount to the customer account. The request message may be approved when there exists any anomaly in the billing information and the requested credit amount is within the credit range calculated for the billing information. The request message may not be approved when the anomaly is not detected in the billing information or the requested credit amount is not within the credit range calculated for the billing information.

When it is identified that the request message has been approved, at step 3a, the dispute resolution module 20 initiates refund of the requested credit amount to the customer account. In some examples, the credit amount may be refunded to the customer account immediately. In some examples, the credit amount may be refunded to the customer account in a next billing cycle. After initiating the credit amount refund, at step 3b, the dispute resolution module 20 sets the request message as “approved”. At step 3c, the dispute resolution module 20 communicates about dispute resolution to the customer.

When it is identified that the request message has not been approved, at step 4, the dispute resolution module 20 detects whether there exists any anomaly in the billing information. When the anomaly is detected in the billing information, at step 5a, the dispute resolution module 20 rejects the request message. At step 5b, the dispute resolution module 20 communicates the customer about the calculated credit range of the billing information and a reason for rejection of the request message. When the anomaly is not detected in the billing information, at step 6a, the dispute resolution module 20 rejects the request message and communicates the customer about the decision of rejection of the request message, at step 6b.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory,
RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

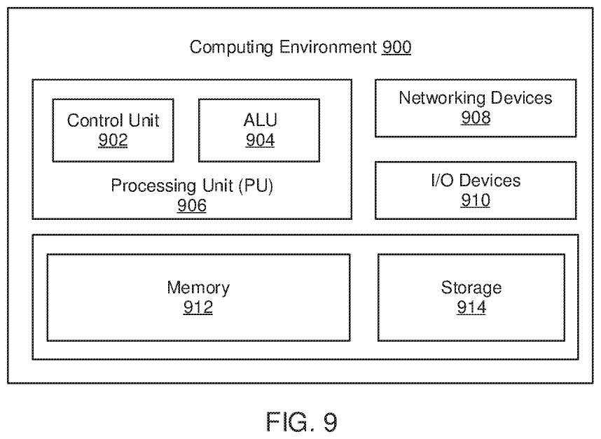

FIG. 9 illustrates an example computing environment 900 implementing a method and the apparatus, as described in FIGS. 4 and 3. As depicted in FIG. 9, the computing environment 900 comprises at least one data processing module 906 that is equipped with a control module 902 and an Arithmetic Logic Unit (ALU) 904, a plurality of networking devices 908 and a plurality Input output, I/O devices 910, a memory 912, a storage 914. The data processing module 906 may be responsible for implementing the method described in FIG. 4. For example, the data processing module 906 may in some embodiments be equivalent to the controlling circuitry of the computing device described above in conjunction with the FIG. 3. The data processing module 906 is capable of executing software instructions stored in memory 912. The data processing module 906 receives commands from the control module 902 in order to perform its processing. Further, any logical and arithmetic operations involved in the execution of the instructions are computed with the help of the ALU 904.

The computer program is loadable into the data processing module 906, which may, for example, be comprised in an electronic apparatus (such as a computing device). When loaded into the data processing module 906, the computer program may be stored in the memory 912 associated with or comprised in the data processing module 906. According to some embodiments, the computer program may, when loaded into and run by the data processing module 906, cause execution of method steps according to, for example, any of the method illustrated in FIG. 4 or otherwise described herein.

The overall computing environment 900 may be composed of multiple homogeneous and/or heterogeneous cores, multiple CPUs of different kinds, special media and other accelerators.

Further, the plurality of data processing modules 906 may be located on a single chip or over multiple chips.

The algorithm comprising of instructions and codes required for the implementation are stored in either the memory 912 or the storage 914 or both. At the time of execution, the instructions may be fetched from the corresponding memory 912 and/or storage 914, and executed by the data processing module 906.

In case of any hardware implementations various networking devices 908 or external I/O devices 910 may be connected to the computing environment to support the implementation through the networking devices 908 and the I/O devices 910.

The embodiments disclosed herein can be implemented through at least one software program running on at least one hardware device and performing network management functions to control the elements. The elements shown in FIG. 9 include blocks which can be at least one of a hardware device, or a combination of hardware device and software module.

1-20. (canceled)

21. A method for dispute resolution in billing information generated for communication services, the method being performed by a computing device, the method comprising:
receiving a request message for a credit amount to be refunded to a customer account, said request message comprising the billing information related to a customer;
determining whether or not to refund the credit amount to the customer account based on an evaluation of the billing information; and
in response to the determination, selectively initiating credit refund to the customer account, altering the billing information, or denying the request message.

22. The method of claim 21, wherein the step of determining whether or not to refund the credit amount to the customer account based on the evaluation of the billing information comprises:
obtaining the billing information;
obtaining historical data of the customer comprising billing information of the customer for a pre-determined time interval;
comparing the billing information with the historical data of the customer to detect whether there exists any anomaly in the billing information;
responsive to the anomaly being detected in the billing information, calculating a credit range of the billing information based on one or more statistical parameters derived from the historical data;
identifying whether the requested credit amount is within the credit range when the anomaly is detected; and
responsive to identifying that the requested credit amount is within the credit range, determining to refund the credit amount to the customer account.

23. The method of claim 22, further comprising:
responsive to identifying that the anomaly is not detected in the billing information or the requested credit amount is not within the credit range of the billing information, determining to alter the billing information or to deny the request message.

24. The method of claim 22, wherein the step of evaluating the billing information by comparing with the historical data of the customer to detect whether there exists any anomaly in the billing information comprises:
obtaining the billing information;
obtaining the historical data of the customer for a pre-determined time interval;
determining one or more statistical parameters from the historical data; and
comparing the billing information with the one or more statistical parameters to detect whether there exists any anomaly in the billing information.

25. The method of claim 22, wherein the step of evaluating the billing information by comparing with the historical data of the customer to detect whether there exists any anomaly in the billing information comprises:
obtaining billing information details and identifying a billing cycle corresponding to the request;
obtaining historical billing information corresponding to one or more billing cycles preceding the identified billing cycle of the customer account; and
comparing the billing information corresponding to the identified billing cycle with the historical billing information to detect whether there exists any anomaly in the billing information.

26. The method of claim 22, wherein the step of calculating the credit range based on analysis of the one or more statistical parameters derived from the historical data comprises:
obtaining a pre-defined tolerance for the billing information;
extracting one or more credit range rules pre-defined for determining the credit range;
evaluating a credit amount in the billing information, the one or more statistical parameters derived for the historical billing information, and the pre-defined tolerance credit in accordance with the one or more credit range rules; and
determining the credit range based on the evaluation.

27. The method of claim 22, wherein the step of initiating the credit refund to the customer account comprises:
refunding the requested credit amount to the customer account, responsive to determining to refund the credit amount to the customer account.

28. The method of claim 22, wherein the step of initiating to alter the billing information or to deny the request message comprises:
performing one or more of: communicating the calculated credit range of the billing information to the customer, altering the billing information and redirecting the request message for manual resolution, responsive to determining that the requested credit amount is not within the credit range and the anomaly is detected in the billing information.

29. The method of claim 28, further comprising:
denying the request message and redirecting the request message for manual resolution, responsive to determining that the anomaly is not detected in the billing information.

30. A computing device for performing dispute resolution in billing information generated for communication services, the computing device comprising processing circuitry and memory operatively coupled to the processing circuitry, the processing circuitry comprising computer program instructions whereby the computing device is configured to:
receive a request message for a credit amount to be refunded to a customer account, said request message comprising the billing information related to a customer;
determine whether or not to refund the credit amount to the customer account based on an evaluation of the billing information; and
in response to the determination, selectively initiate credit refund to the customer account, alter the billing information, or deny the request message.

31. The computing device of claim 30, wherein the computing device is configured to determine whether or not to refund the credit amount to the customer account based on the evaluation of the billing information by:
obtaining the billing information;
obtaining historical data of the customer comprising billing information of the customer for a pre-determined time interval;
comparing the billing information with the historical data of the customer to detect whether there exists any anomaly in the billing information;
when the anomaly is detected in the billing information, calculating a credit range of the billing information based on one or more statistical parameters derived from the historical data;
identifying whether a requested credit amount is within the credit range when the anomaly is detected; and
when it has been identified that the requested credit amount is within the credit range, determining to refund the credit amount to the customer account.

32. The computing device of claim 31, the computing device being configured to, responsive to identifying that the anomaly is not detected in the billing information or the requested credit amount is not within the credit range of the billing information:
determine whether to alter the billing information or to deny the request message.

33. The computing device of claim 31, wherein the computing device is configured to evaluate the billing information by comparing with the historical data of the customer to detect whether there exists any anomaly in the billing information by:
obtaining the billing information;
obtaining the historical data of the customer for a pre-determined time interval;
determining one or more statistical parameters from the historical data; and
comparing the billing information with the one or more statistical parameters to detect whether there exists any anomaly in the billing information.

34. The computing device of claim 31, wherein the computing device is configured to evaluate the billing information by comparing with the historical data of the customer to detect whether there exists any anomaly in the billing information by:
obtaining billing information details and identifying the billing cycle corresponding to the request;
obtaining historical billing information corresponding to one or more billing cycles preceding the identified billing cycle of the customer account; and
comparing the billing information corresponding to the identified billing cycle with the historical billing information to detect whether there exists any anomaly in the billing information.

35. The computing device of claim 31, wherein the computing device is configured to calculate the credit range based on analysis of the one or more statistical parameters derived from the historical data by:
obtaining a pre-defined tolerance for the billing information;
extracting one or more credit range rules pre-defined for determining the credit range;
evaluating a credit amount in the billing information, the one or more statistical parameters derived for the historical billing information, and the pre-defined tolerance credit in accordance with the one or more credit range rules; and
based on the evaluation, determining the credit range.

36. The computing device of claim 31, wherein the computing device is configured to initiate the credit refund to the customer account by:
refunding the requested credit amount to the customer account, when it has been determined to refund the credit amount to the customer account.

37. The computing device of claim 30, wherein the computing device is configured to alter the billing information or to deny the request message by performing one or more of: communicating the calculated credit range of the billing information to the customer, altering the billing information and redirecting the request message for manual resolution, responsive to determining that the requested credit amount is not within the credit range and the anomaly is detected in the billing information.

38. The computing device of claim 37, the computing device is further configured to:
deny the request message and redirect the request message for manual resolution, responsive to determining that the anomaly is not detected in the billing information.

39. A billing dispute resolution system for dispute resolution in billing information generated for communication services, the billing dispute resolution system comprising the computing device of claim 30.

40. A non-transitory computer-readable medium, having thereon a computer program comprising program instructions, the computer program being loadable into a data processing unit and configured to cause execution of the method of claim 21 when the computer program is run by the data processing unit.
